(19) United States
(12) Patent Application Publication
(10) Pub. No.: US 2017/0237466 A1
(43) Pub. Date: Aug. 17, 2017

(54) Sensor System with Energy Harvesting

(71) Applicant: William N. Carr, Raleigh, NC (US)

(72) Inventor: William N. Carr, Raleigh, NC (US)

(21) Appl. No.: 15/434,939

(22) Filed: Feb. 16, 2017

Related U.S. Application Data
(60) Provisional application No. 62/388,989, filed on Feb. 16, 2016.

(51) Int. Cl. H04B 5/00; H02J 50/12

(52) U.S. Cl. CPC H04B 5/0031; H02J 50/12; H04B 5/0037

(57) ABSTRACT

A sensor system with energy harvesting has an energy-harvesting mode of operation and a load-enabling mode of operation, enabled at separate times. The system includes an antenna, an impedance-matching network, an RF switch, inductive and diode components (for forming a resonant RF-to-DC voltage multiplication circuit in conjunction with other elements of the system), a DC switch, an energy-storage device, and a primary load circuit.

### STATEMENT OF RELATED CASES

This case claims priority of U.S. Pat. App. Ser. No. 62/388,989 filed Feb. 16, 2016 and which is incorporated herein by reference.

### FIELD OF THE INVENTION

This invention relates generally to harvesting environmental energy, and more particularly to harvesting energy from RF signals for powering very low power sensors.

### BACKGROUND OF THE INVENTION

In many sensor applications, the sensors operate at very low power levels—as low as microwatts and even nanowatts. Such applications often require that the sensors be incorporated into wireless networks and operate with minimal power supplies. Power supplies that include energy-harvesting technology compatible with the aforementioned ultra-low power levels are, in some cases, used to provide power in these applications.

FIG. 1 depicts an energy-harvesting system disclosed in U.S. Pat. No. 7,084,605. Energy-harvesting system 100 includes energy-harvesting antenna 102, inductive element 104, variable capacitive element 106, rectifier 108, intermediate storage capacitor 110, switch 112, control circuitry 116, DC energy output 114, final energy-storage device 118.

Energy-harvesting system 100 operates to charge final energy-storage device 118. Inductive element 104 and variable capacitive element 106 form a tuning circuit to maximize the amount of energy harvested from the environment. Rectifier 108 converts the RF or AC energy received from antenna 102 into a DC energy, which is stored in capacitor 110. Switch 112 controls the flow of DC energy 114 from storage capacitor 110 to final energy storage device 118. The switch provides energy to operate electronic devices at fixed time intervals while also storing any additional unused energy on final energy storage device 118. Switch 112 also functions to provide an input to control circuitry 116 to tune circuit elements 104 and 106 for best energy harvesting.

FIG. 2 depicts an energy-harvesting system for use with a wireless sensor, as disclosed in U.S. Pat. No. 8,552,597. Energy-harvesting system 200 includes energy-harvesting antenna 220, super capacitor 222, DC/DC converter 224, battery and charger 226, and power switch 228. System 200 is directly connected to sensor node 230 and communications antenna 232. The system can be bandpass or all-pass filtered to match all AM frequencies to maximize the capture of harvestable energy to the extent possible. Supercapacitor 222 provides a buffer for rechargeable battery 226. Harvested energy can be used to power sensor node 230 or charge the sensor node's local power source 226. The system is disclosed to provide power of over 10 mW to load devices.

### SUMMARY

The present invention provides a source of switched DC power for a variety of sensor and control systems, including, without limitation, biomedical devices and remote and/or portable environmental sensors.

The illustrative embodiment of the invention is a sensor system including a primary load circuit with energy harvesting. In the illustrative embodiment, the primary load circuit is an RFID transponder, which can be structured for operation over a frequency range from about 100 kHz up to about 40 GHz and in accordance with any number of protocols including IEEE 802.15.4, ISO 18000, IEEE 802.15.1 (Bluetooth), and IEEE 802.11 (Wi-Fi). In one embodiment, the system is used to wake-up and/or synchronize a battery-powered UHF communication node within a network having a plurality of such nodes. By virtue of the invention and, in particularly, the manner in which energy harvesting is implemented, the distance between a transponder (included in the sensor system) and a remote interrogator is greatly increased compared to the prior art.

In accordance with an illustrative embodiment, the system includes an antenna, an impedance-matching network, an RF switch, inductive and diode components (for forming a resonant RF-to-DC voltage multiplication circuit in conjunction with other elements of the system), a DC switch, an energy-storage device, and a primary load circuit.

In accordance with the illustrative embodiment and unlike the prior art, the same antenna is used for both harvesting RF energy and for communications (e.g., RFID transponder communications, etc.). This reduces the size of the sensor system. In some embodiments, the antenna is a multi-band antenna.

In operation of some embodiments of the invention, incident RF energy that excites the antenna is coupled, at different times, into one of: (1) the energy storage device (e.g., capacitor, rechargeable battery, etc.) or (2) the primary load circuit. The destination for the harvested energy depends upon the state of the system. More particularly, the RF switch operates to direct the harvested energy to the energy storage device until a pre-determined “high” threshold is exceeded. In the illustrative embodiment, this high threshold is a specified voltage measured across the energy storage device.

Energy harvesting is implemented via a resonant voltage multiplication circuit. This circuit enables energy to be stored at a voltage level higher than is possible without the multiplier. The resonant voltage multiplication circuit permits harvesting charge in nano and microJoule increments. Typical circuits providing an RF-to-DC voltage multiplier include a diode rectifier and a DC-to-DC up-converter. These circuits do not operate at nanoWatt power levels. The voltage multiplication circuit is a resonant LC loop, wherein the capacitance of a semiconductor rectifying diode determines the resonant frequency of the voltage multiplier. This same diode, which in the illustrative embodiment is a Schottky diode, provides the unidirectional charging current to the energy storage element.

When the high voltage threshold is exceeded, in some embodiments, the DC switch enables harvested energy from the energy storage device to flow to the primary load circuit. Also, the state of the RF switch changes so that voltage multiplication is disconnected and the primary load circuit is coupled to the antenna for communications. The DC switch continues to electrically couple the energy storage device to the primary load circuit until the energy available from the energy storage device drops below a “low” voltage threshold. When the voltage drops below this low threshold, the RF switch and DC switch change state to enable energy harvesting and disconnect the primary load circuit from the antenna. Thus, in the illustrative embodiment, the system cycles between these two modes of operation as a function of the voltage across the energy storage device.

The impedance-matching circuit ensures that the RF impedance presented to the antenna by the voltage multiplier and the impedance presented to the antenna by the primary load circuit is the same. Impedance matching provides the maximum RF power transfer between the antenna and the primary load circuit, therefore providing a maximum range for the separation distance between, for example, an RFID transponder (as an example of the primary load circuit) and an RFID interrogator.

In some other embodiments, the sensor system includes one or more of the following:
secondary load circuit(s) and tertiary load circuit(s), such as and without limitation, additional sensors (such as sensors for temperature, humidity, electrical conductivity, corrosion, media permittivity, inertial motion, fluid acidity, heartbeat rate, breath rate, magnetic field, gravitational vector force, and localized imaging), microprocessors, Internet connections, optical communications links, and actuatable control devices;
additional control circuits;
one or more batteries;
devices/circuits that are operable to tune the operation at different frequencies; and
devices/circuits that harvest RF energy at frequencies in addition to the operational RFID communications frequency.

In addition to its dual-purpose antenna, embodiments of the inventions include one or more of the following innovations, among any others:
Power is supplied to the primary load circuit only when the energy that is harvested reaches a threshold level. In other words, the energy harvesting circuit and the primary load circuit are electrically coupled to the antenna at different times. This eliminates the undesirable loading effect of the energy harvesting circuit on the antenna that would otherwise occur if these two circuits were connected to the antenna at the same time. This enables the primary load circuit—the RFID transponder in the illustrative embodiment—to operate with lower ambient RF power levels.
The energy-harvesting loop provides resonant, rectifying voltage multiplication. The resonant characteristic of the harvesting loop permits direct charging of the energy storage device to a higher voltage than is possible with a non-resonant loop. Not used in prior-art RFID systems, this permits charging of the energy storage device with incident RF power levels that are an order of magnitude smaller than required to operate an RFID transponder.
In this regard, the prior-art system depicted in FIG. 1 includes a resonant circuit, but this is a parallel, resonant-circuit connection that does not enable directly charging the final energy storage device 118 to a voltage greater than the RF voltage provided by antenna 102. Again, in embodiments of the present invention, the series resonant loop circuit including the resonant voltage multiplier is capable of charging the energy storage device to a voltage level that is greater than the RF voltage received from the antenna.
The prior-art system depicted in FIG. 2 depicts a DC/DC converter 224, which increases the DC voltage available from capacitor 222. This converter is generally used to step-up the harvested DC voltage. However, such converters do not operate at the power levels of interest for embodiments of the present invention. In particular, typical RFID transponders operate at microwatt power levels. The inventor's use of the resonant voltage multiplier enables embodiments of the present invention to harvest RF power at nanoWatt levels, as enabled by the increased RF-to-DC voltage conversion.

In some embodiments, the sensor system harvests RF power from a single RF source, such as an RFID interrogator, at a single frequency. In some other embodiments, the sensor system is powered from multiple RF sources at multiple frequencies. In embodiments in which power is obtained from multiple RF sources, the sensor system includes a multi-frequency antenna, such as is disclosed in U.S. Pat. Nos. 8,581,793, 9,160,079, and 9,160,070, and matched resonant voltage multiplication circuits, that incrementally charge a single energy storage device (e.g., capacitor, etc.). For example, in one embodiment, the sensor system is configured with resonant harvesting circuits for multiple frequencies such as 1 MHz, 98 MHz and 915 MHz, whereas the primary load circuit, embodied as an RFID transponder, operates only within the 915 MHz band. The sensor system, however, is capable of harvesting power from all three wavelength bands to power the RFID transponder.

It will often be the case for such embodiments that energy is harvested from an RF energy source that, although readily available as a harvesting source, is not at the preferred frequency of the primary load circuit (e.g., not at the frequency preferred for RFID interrogation). In some of such embodiments, one or more harvesting circuits are provided to charge the energy storage device more or less continuously from ambient RF energy in the environment, such as a commercial AM, FM or TV broadcast station. In some embodiments, the energy storage device is maintained at a substantially “full” level of charge as a result of accumulated harvesting. The primary load circuit (e.g., RFID transponder) may operate in any of several available unlicensed frequency bands such as 125 kHz, 13.56 MHz, 860-960 MHz, or 2.45 GHz while the energy harvester is powered from other RF sources such as AM, FM or TV broadcast stations. In embodiments of the present invention, the energy harvesting circuits do not load the micro-power RFID transponder when it is enabled.

### BRIEF DESCRIPTION OF THE DRAWINGS

FIG. 1 depicts a first prior-art energy harvesting system.

FIG. 2 depicts a second prior-art energy harvesting system.

FIGS. 3A and 3B depict a block diagram of a sensor system in accordance with an illustrative embodiment of the present invention.

FIG. 4A depicts an embodiment of the sensor system of FIGS. 3A/3B.

FIG. 4B depicts an embodiment of the sensor system of FIGS. 3A/3B wherein plural harvester circuits tuned for different frequencies and all charging the same energy storage device simultaneously are included.

FIG. 5 depicts an embodiment of the sensor system of FIGS. 3A/3B wherein RF switching is controlled by a Schmitt gate and a transfer gate.

FIG. 6 depicts the control voltage and functions of sensor system of FIG. 5.

FIG. 7 depicts an embodiment of the sensor system of FIGS. 3A/3B with a secondary load circuit and programmed control connection to a battery power source.

FIG. 8 depicts an embodiment of the sensor system of FIGS. 3A/3B with secondary load circuits and a delay connection to a battery power source for a timed interval.

FIG. 9 depicts an embodiment of the sensor system of FIGS. 3A/3B with secondary load circuits and external devices wherein a battery power source is connected to the secondary load circuits under programmed control from the first load circuit.

FIG. 10 depicts an embodiment of the sensor system of FIGS. 3A/3B wherein the impedance matching network is a T-match filter.

FIG. 11A depicts and embodiment of the sensor system of FIGS. 3A/3B wherein the RF frequency for operation is tuned by a variable capacitance device under programmed control.

FIG. 11B depicts an embodiment of the variable capacitance device used in the embodiment of FIG. 11A.

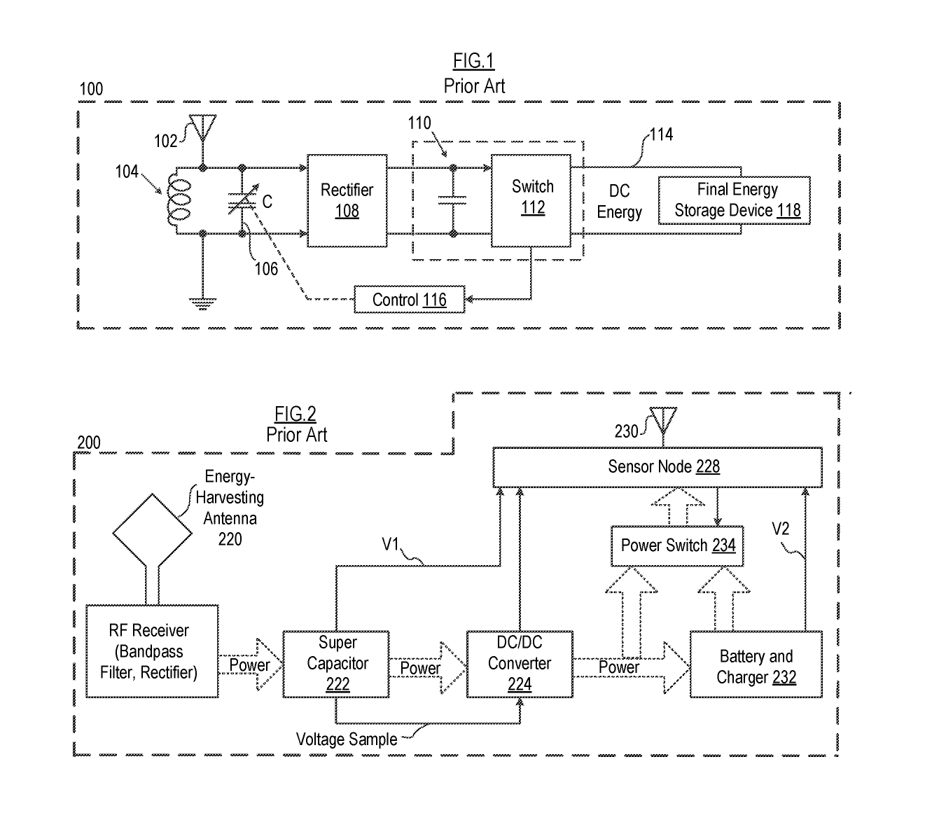

### DETAILED DESCRIPTION

The following terms and their inflected forms are explicitly defined for use in this disclosure and the appended claims:
“RFID device” means a communication sensor, operated in a passive, semi-passive, or active mode. The sensing function includes a means of self-identification and, in some embodiments, one or more environmental sensors, actuators, controllers, etc.
“Load circuit” means the portion of the sensor system that consumes power, such as, without limitation, integrated circuits, sensors, actuators, imagers, LEDs, and lasers.
“Semi-passive RFID” means an RFID device powered with a local DC source including harvested energy stored in an energy storage device and communicating with an external interrogator via means of reflected signal carrier.

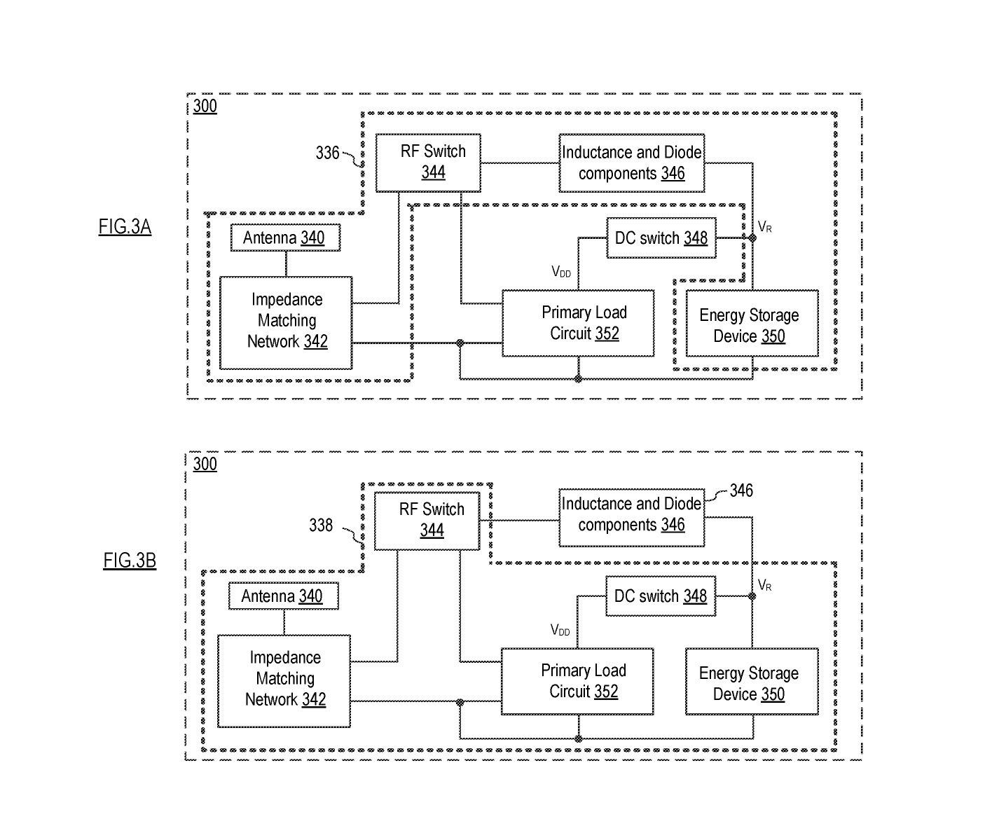

FIGS. 3A and 3B depict a block diagram of sensor system 300 in accordance with the illustrative embodiment of the present invention. Sensor system 300 includes antenna 340, impedance matching network 342, RF switch 344, Inductance and Diode components (partial RF-to-DC voltage multiplier circuit) 346, DC switch 348, energy storage device 350, and primary load circuit 352.

Sensor system 300 is characterized as having energy-harvesting circuit 336 and load-enabling circuit 338, with some elements in common. Energy-harvesting circuit (or RF-to-DC voltage multiplier) 336 includes antenna 340, impedance matching network 342, RF switch 344, inductance and diode components 346, and energy storage device 350. Load-enabling circuit 338 includes antenna 340, impedance matching network 342, RF switch 344, DC switch 348, energy storage device 350 and primary load circuit 352.

Sensor system 300 receives RF power into impedance matching network 342 through antenna 340. The RF voltage, which is output from impedance matching network 342, is directed to either (the rest of) energy-harvesting circuit 336 or (the rest of) load-enabling circuit 338, depending on the position of RF switch 344. The position of the RF switch is a function of the state of sensor system 300; in particular, the charge level of energy storage device 350.

When RF switch 344 is in a first position, it enables energy harvesting. In this mode of operation, RF energy received through the antenna from a remote source charges energy storage device 350 until voltage V_{R} across its terminals exceeds a “high” threshold voltage level, as monitored by DC switch 348. When the high voltage threshold is exceeded, the mode of operation changes; primary load circuit 352 is enabled via DC switch 348. Specifically, the DC switch electrically couples energy storage device 350 to primary load circuit 352, thereby supplying DC power thereto. This enables primary load circuit 352 for operation with the voltage V_{DD}=V_{R}. Also, during this same switching interval, RF switch 344 changes to a second position disconnecting the antenna from the energy harvesting circuit and connecting it to the primary load circuit.

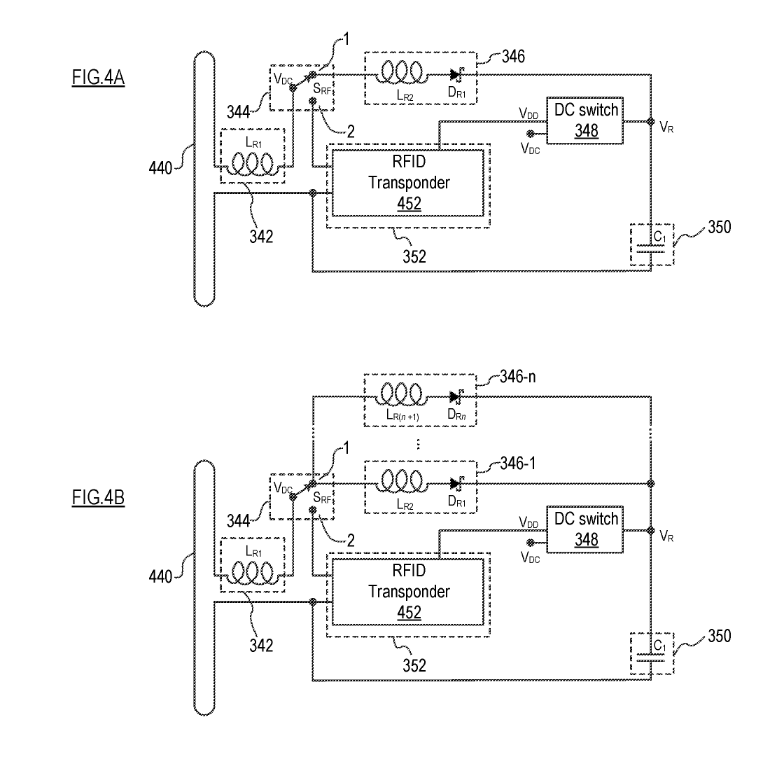

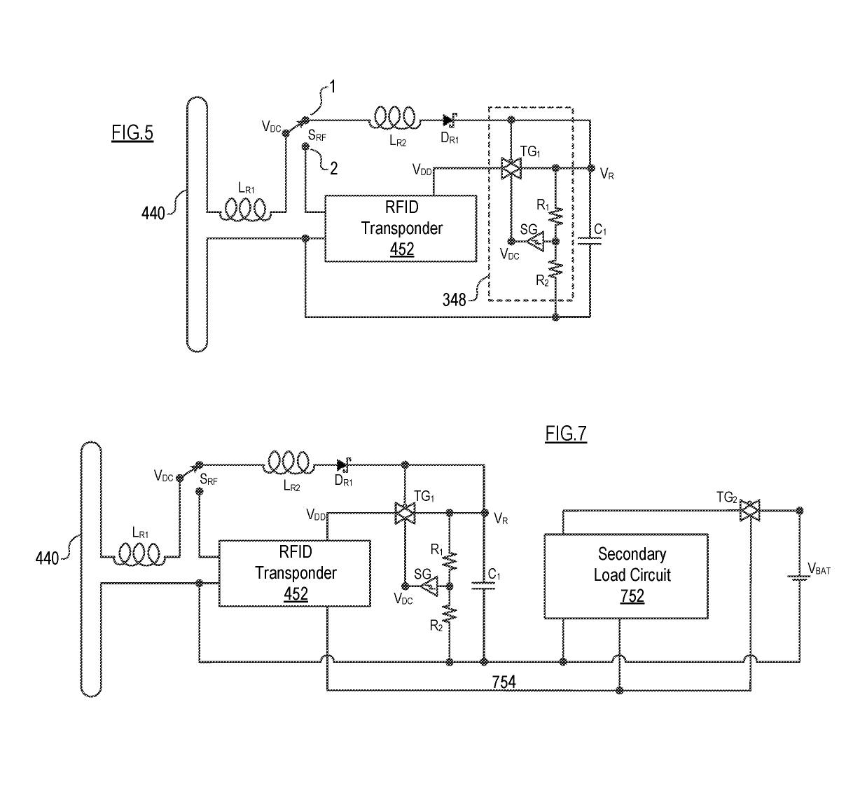

FIGS. 4A and 4B depict an embodiment of sensor system 300 wherein antenna 340 is implemented by dipole antenna 440, impedance matching network 342 is implemented via inductor L_{R1}, RF switch 340 is implemented by single-pole double-throw (SPDT) switch S_{RF}, groupings of inductive and diode components 346-1 to 346-n are each implemented via an inductor and a Shottky diode (i.e., L_{R2} and D_{R1} through L_{Rn+1} and D_{Rn}, respectively), energy storage device 350 is implemented by capacitor C₁, and primary load circuit 352 is implemented as RFID transponder 452.

The inductive and diode components 346-1 through 346-n tune the respective harvesting circuits providing RF harvesting at n different frequencies such as a UHF waveband and a lower HF or LF band. The selected frequency bands should be adequately separated to avoid cross talk interference. It is within the capabilities of those skilled in the art to select appropriately separated frequencies to avoid cross talk.

In some embodiments, RF switch S_{RF} comprises a GaAs JFET transistor and a silicon NPN transistor each controlling the two arms of the SPDT switch. The JFET provides a low resistive impedance source-drain circuit path with zero gate-voltage bias for RF energy harvesting.

RF switch S_{RF}, at position “1” as depicted in FIGS. 4A and 4B, enables energy harvesting. The energy harvesting loop includes inductive RF-to-DC voltage multiplication, which provides significant benefits over the prior art. RF power received by antenna 440 is partially rectified by the Schottky diode(s). The energy-harvesting circuit is an RLC resonant loop; the capacitance of Schottky diode(s) resonates with the series loop inductance provided by (in FIG. 4a) inductors L_{R1}, L_{R2}, and antenna 440. The harvesting loop resonates at the frequency of the external RF power source (e.g., RFID interrogator, etc.). The resonant characteristic of the harvesting loop enables charging the energy storage device to a higher voltage than is possible with a non-resonant circuit.

FIG. 5 depicts an embodiment of sensor system 300 wherein DC switch 348 is embodied as transfer gate TG₁, Schmitt gate SG, and resistors R₁ and R₂. In this embodiment, and all other embodiments depicted herein, RF switch S_{RF} is controlled by the DC switch. It is important to note that, due to this arrangement, primary load circuit 352—RFID transponder 452 in the illustrative embodiments—does not receive DC power during those times when RF energy harvesting is enabled. Harvesting and transponder functions are enabled at different times through RF switch S_{RF}, which is itself controlled by the control voltage V_{DC}. In particular, when (harvested) voltage V_{R} (the voltage across the energy storage device) exceeds the high threshold level, control voltage V_{DC} enables the following:
(1) DC switch 348 connects the supply voltage V_{R} into RFID transponder 452 and actuates the RF switch S_{RF} from position 1 to position 2.
(2) Due to the move from position 1 to position 2, the energy harvesting circuit(s) are disabled.
(3) Due to the move from position 1 to position 2, antenna 440 and its impedance matching network are connected to RFID transponder 452.
   RFID transponder 452 is made operational through this switching action and a wireless communication link is established with a remote RFID interrogator (not depicted), through antenna 440.

The DC threshold sensing function is provided by DC switch 348. With RF switch S_{RF} in position “1” for energy harvesting, the resonant voltage multiplier is enabled and capacitor C₁ charges. Energy harvesting is disabled when the voltage V_{R} across capacitor C₁ exceeds the pre-determined high threshold level, as determined by the voltage divider connection R₁ and R₂. When the voltage exceeds the threshold, Schmitt gate SG goes to a high state, supplying control voltage V_{DC} to transfer gate TG₁ and RF switch S_{RF}. The enabled transfer gate TG1 causes the voltage level V_{DD} across RFID transponder to increase from a minimal value up to approximately V_{R} (the voltage level of “fully” charged capacitor C₁). Control voltage V_{DC} causes RF switch S_{RF} to move to position “2”. There is a hysteresis in voltage V_{DC} provided from Schmitt gate SG that enables the direction connection V_{R}=V_{DD} throughout the hysteresis range of the Schmitt gate.

Thus enabled, RFID transponder 452 continues to operate until the voltage V_{R} falls below a pre-determined lower threshold voltage, indicating that the energy storage device—capacitor C₁ in the illustrative embodiment—has drained to the point that it cannot sustain the operation of the RFID transponder. Schmitt gate SG responds when the voltage V_{R} falls below the lower voltage threshold and the control voltage V_{DC} goes low. The transfer gate TG₁ then stops the flow of energy to the primary load circuit—RFID transponder 452 in the illustrative embodiment—and causes RF switch S_{RF} to move to position 1, thereby disconnecting the RFID transponder and re-establishing the energy harvesting circuit. The charging cycle then repeats, etc. In some other embodiments, voltage V_{DC} is supplied directly as V_{DD} into the primary load circuit 352 and transfer gate TG₁ is not used.

The high and low threshold voltages are determined from calibrations and designed into the DC switch circuit. A typical value for the high threshold is about 3.5 volts and a typical value for the low threshold is about 1.5 volts.

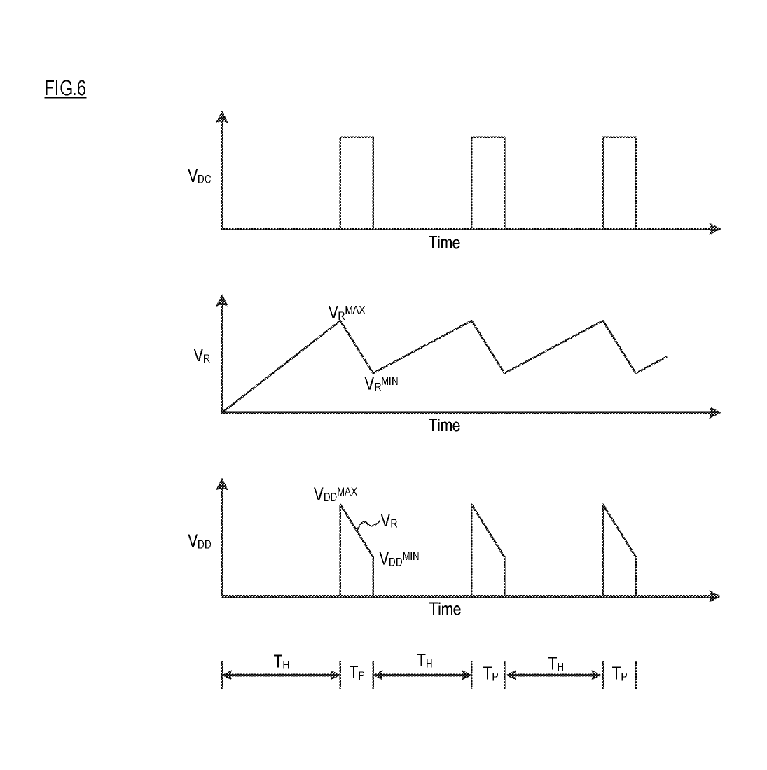

FIG. 6 depicts the sequence of harvesting operation T_{H} and RFID transponder operation T_{P}. The plot depicting voltage V_{R} across the energy storage device shows voltage V_{R} rising to a maximum V_{R}^{MAX} during the energy harvesting operation. Once the “high” threshold voltage is exceeded, control voltage V_{DC} goes high and stored energy from the energy storage device is directed to the RFID transponder. The plot depicting voltage V_{DD} across the transponder shows voltage V_{DD} at its peak value V_{DD}^{MAX} when the transponder is first switched in. As the energy storage device drains, supplying energy to the primary load circuit transponder, voltage V_{DD} falls along with voltage V_{R}. When the voltage across the energy storage device (i.e., capacitor C₁) falls past the low threshold voltage value V_{R}^{MIN}, at which point the voltage across the transponder reaches its minimum value V_{DD}^{MIN}, control voltage VDC goes low and energy harvesting operation T_{H} resumes.

FIG. 7 depicts an embodiment of sensor system 300 that includes secondary load circuit 752 and a data bus or control line 754 from RFID transponder 452 to the secondary load circuit. In this embodiment, secondary load circuit 752 is enabled via second transfer gate TG₂ and controlled from the RFID transponder. Second load circuit is enabled typically only during operation of the RFID transponder and thus energy drain from battery power source V_{BAT} is minimal. This embodiment is particularly useful for applications in which the available battery is very small and it is desirable to conserve its stored energy.

FIG. 8 depicts an embodiment of sensor system 300 that provides a delayed connection to battery power source V_{BAT} for a timed interval. In this embodiment, Schmitt gate SG provides a control voltage V_{DC} to control second transfer gate TG₂. The control circuit electrically couples battery V_{BAT} for powering both RFID transponder 452 and second load circuit 752 for a fixed interval of time. The circuit comprised of resistors R₃, R₄, capacitor C₂ and diode D_{R2} provide the voltage which enables the transfer gate TG₂ supplying the battery voltage V_{BAT} to both load circuits for a fixed time interval. This embodiment is particularly useful when RFID transponder 452 is used to control loads, such as secondary load circuit 752 (via data bus 754) and tertiary load circuits 852 (via data and power bus 856) requiring additional power and wherein the operational interval of the RFID transponder is extended in time.

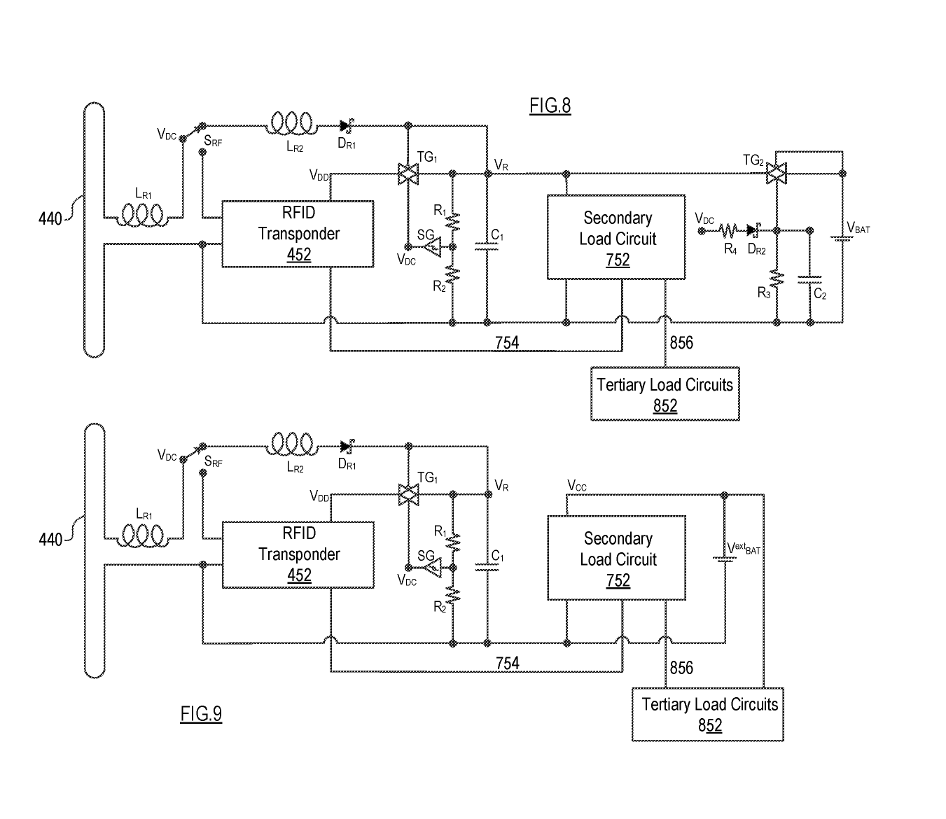

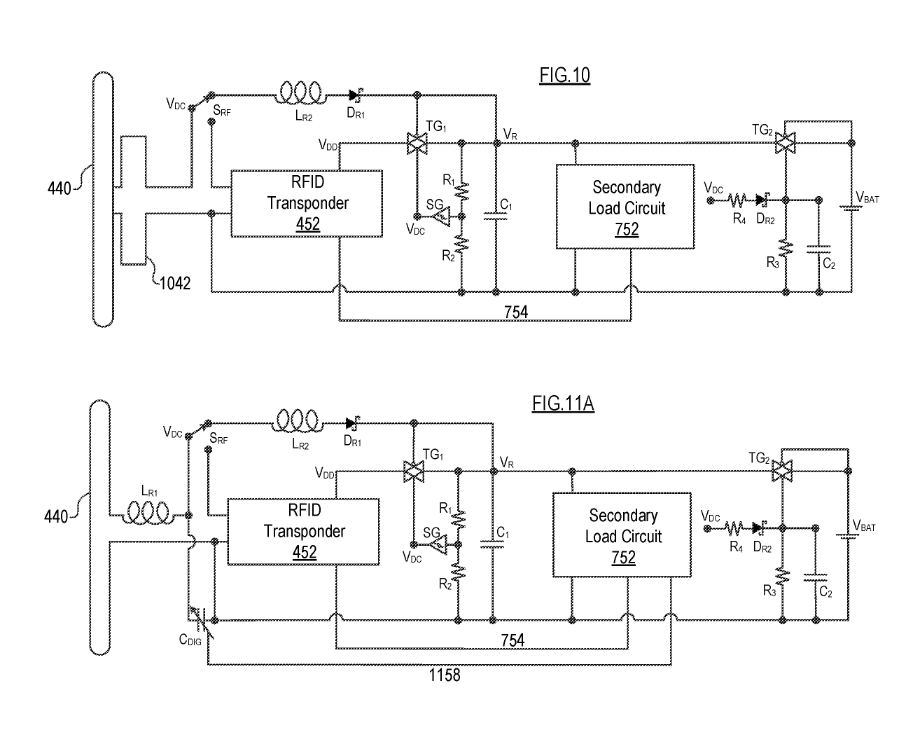

FIG. 9 depicts an embodiment of sensor system 300 wherein external power source V^{ext}_{BAT} is continually supplying power to secondary load circuit 752. The secondary load circuit is controlled via RFID transponder 452 over data bus 754. In this embodiment, tertiary load circuits 852, which are electrically connected to secondary load circuit 752 via data and power bus 856 can draw watts or even kilowatts from power source V^{ext}_{BAT}.

FIG. 10 depicts an embodiment of sensor system 300 in which impedance matching network 342 is implemented as T-match filter 1042. This embodiment is suitable for UHF sensors (operating at frequencies in the range of 300 MHz to 3 GHz).

T-match filter 1042 can be made by patterning of metallization on printed circuit boards and flexible substrates. A typical T-match filter has an equivalent inductive impedance component that is compatible with the use of the impedance element (e.g., L_{R2}, etc.) in the RF-to-DC voltage multiplication circuit.

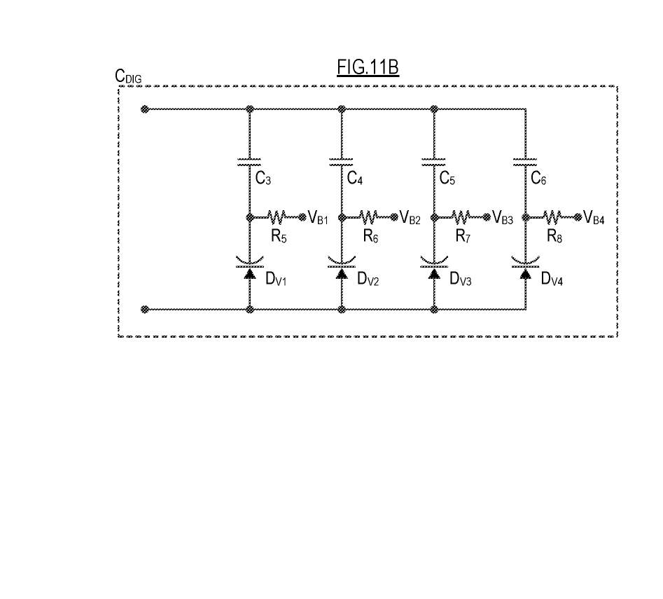

FIG. 11A depicts an embodiment of sensor system 300 in which the RF frequency for operation is tuned by variable capacitance device C_{DIG} under the control of secondary load circuit 752 over data bus 1158. In this embodiment, a controlled capacitance is connected across the output of impedance matching network L_{R1} to provide a desired impedance match to antenna 440/impedance matching network L_{R1}. Small incremental changes in the capacitance of variable capacitance device C_{DIG} shift the resonant frequency of sensor system 300. In some other embodiments, variable capacitance device C_{DIG} is under the autonomous control of RFID transponder 452. In yet some additional embodiments, a remote RFID interrogator controls the capacitance through RFID transponder 452.

FIG. 11B depicts an embodiment of C_{DIG} for providing a variable capacitance. In this embodiment, capacitance is controlled with 4-bit digital data bus 1158. In this circuit, each control bit changes the capacitance of respective varactor diodes D_{V1}, D_{V2}, D_{V3}, D_{V4}. The capacitances of the varactor diodes are much smaller than that of respective coupling capacitors C₃, C₄, C₅ and C₆. Respective resistors R₅, R₆, R₇, and R₈ have impedances that are much higher than the reactance of capacitors C₃ through C₆ and do not load the variable capacitor circuit. The sum of the parallel connection of varactor-diode capacitors biased under programmed bus control provides variable capacitor C_{DIG} that tunes the wireless sensor.

It is to be understood that although this disclosure teaches many examples of embodiments in accordance with the present teachings, many additional variations of the invention can easily be devised by those skilled in the art after reading this disclosure. As a consequence, the scope of the present invention is to be determined by the following claims.

What is claimed:

1. A sensor system comprising:
an RF front end that receives and switches RF energy;
an energy-harvesting circuit that provides resonant RF-to-DC voltage multiplication, the energy-harvesting circuit including:
(a) the RF front end,
(b) inductive and capacitive elements to provide a partially rectifying, resonant LC loop, and
(c) an energy storage device; and
a load-enabling circuit that powers a primary load circuit from the energy storage device, the load-enabling circuit including:
(a) the RF front end,
(b) the primary load circuit, and
(c) the energy storage device.

2. The sensor system of claim 1 wherein the RF front end comprises:
an antenna that both receives RF energy from ambient sources thereof and transmits signals originating from the primary load circuit;
an impedance matching network that is coupled to the antenna; and
an RF switch that switches the received RF energy between the energy-harvesting circuit and the load-enabling circuit.

3. The sensor system of claim 1 wherein the inductive and capacitive elements comprise an inductor and a Schottky diode connected in series.

4. The sensor system of claim 1 wherein the energy storage device is a capacitor or a rechargeable battery.

5. The sensor system of claim 1 wherein the load-enabling circuit further comprises a DC switch, wherein the DC switch is electrically coupled to the energy storage device and the primary load circuit.

6. The sensor system of claim 5 wherein the DC switch comprises a transfer gate and a Schmitt gate.

7. The sensor system of claim 5 wherein the DC switch comprises a Schmitt gate and is configured so that when a voltage across the energy storage device exceeds a first threshold, the Schmitt gate goes to a high state generating a DC control voltage.

8. The sensor system of claim 7 wherein the RF front end comprises an RF switch that switches received RF energy between the energy-harvesting circuit and the load-enabling circuit, and further wherein, when the control voltage is generated by the Schmitt gate:
(a) a DC supply voltage from the energy storage device is coupled into the primary load circuit; and
(b) the RF switch changes state, disabling energy harvesting and electrically coupling the primary load circuit to the RF front end.

9. The sensor system of claim 1 wherein the load-enabling circuit further includes a secondary load circuit, wherein the primary load circuit controls the secondary load circuit.

10. The sensor system of claim 2 further comprising a variable capacitive device electrically connected to the impedance matching network, wherein the variable capacitive device controls a resonance frequency of the sensor system, thereby dictating which frequencies of RF energy are harvested by the sensor system.

11. The sensor system of claim 2 wherein the antenna is a multi-band antenna, the RF front end further comprising plural groups of resonant energy-harvesting inductive and capacitive elements, each group tuned for a frequency band of the multi-band antenna, said respective energy-harvesting circuits all electrically coupled to a common energy storage device.

12. The sensor system of claim 1 wherein the primary load circuit is a RFID transponder.

13. A method for operating a sensor system, the method comprising:
receiving, at an antenna, RF energy from an ambient source of RF energy;
harvesting the received RF energy in an energy storage device via a circuit that provides resonant voltage multiplication;
when a voltage across the energy storage device exceeds a first threshold:
(a) electrically coupling the energy storage device to a primary load circuit, enabling energy to flow from the energy storage device to the primary load circuit, and
(b) changing the state of an RF switch, wherein the change in state:
(i) decouples the circuit that provides resonant voltage multiplication from the antenna, and
(ii) electrically couples the primary load circuit to the antenna so that the primary load circuit can transmit a signal;
when the voltage across the energy storage device drops below a second threshold:
(a) electrically decoupling the primary load circuit from the energy storage device,
(b) changing the state of the RF switch, wherein the change in state:
(i) decouples the primary load circuit from the antenna; and
(ii) electrically couples the circuit that provides resonant voltage multiplication to the antenna so that RF energy is harvested.

14. The method of claim 13 wherein the source of RF energy is an RFID transponder.

15. A method for operating a sensor system, the method comprising switching between an energy harvesting mode and a load-enabling mode as follows:
enabling the energy harvesting mode when a voltage measured across an energy storage device falls below a first threshold voltage, the energy harvesting mode including:
(a) processing RF energy received at an antenna via resonant voltage multiplication, and
(b) storing the processed RF energy in the energy storage device; and
enabling the load-enabling mode when the voltage measured across the energy storage device exceeds a second threshold voltage, the load-enabling mode including:
(a) electrically couple the energy storage device to a primary load circuit, and
(b) transmitting a signal from the primary load circuit via the antenna.

16. The method of claim 15 and further wherein enabling the load-enabling mode further comprises:
(c) disabling the processing of the received RF energy, and
(d) electrically coupling the antenna to the primary load circuit.

17. The method of claim 15 and further wherein enabling the energy-harvesting mode further comprises:
(c) decoupling the primary load circuit from the energy storage device,
(d) decoupling the primary load circuit from the antenna, and
(e) coupling the antenna to inductive and capacitive elements that collectively provide resonant voltage multiplication.

18. The method of claim 15 wherein processing RF energy further comprises receiving RF energy sourced from plural sources, each source radiating RF energy at a different frequency, wherein the antenna is a multi-frequency antenna and the RF energy at each different frequency is processed by frequency matched resonant voltage multiplication circuits.

19. The method of claim 15 wherein enabling the load-enabling mode further comprises generating, from a Schottky diode, a control voltage that causes a transfer gate to electrically couple the energy storage device to the primary load circuit.

20. The method of claim 15 wherein enabling the load-enabling mode further comprises controlling, from the primary load circuit, a secondary load circuit.
